(19) United States
(12) Patent Application Publication
(10) Pub. No.: US 2004/0119186 A1
(43) Pub. Date: Jun. 24, 2004

(54) Method for recycling and reusing corrugated paper

(76) Inventor: Shih-Hui Lee, Yenchao Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/322,549

(22) Filed: Dec. 19, 2002

(51) Int. Cl. B29B 17/00; B29C 43/02; D21B 1/08

(52) U.S. Cl. 264/69; 264/140; 264/330; 264/914

(57) ABSTRACT

A method for recycling and reusing corrugated paper comprising the steps of: pulverizing the waste corrugated paper into a plurality of scraps; adding viscose to mix with the scraps; agitating viscose and the scraps so that a surface of each scrap is stuck with a thin layer of viscose; filling the scraps with viscose into a model; compressing the scraps for solidifying the scraps so as to form a shaped product; and drying the shaped product. The size of the corrugated paper is less than 10 cm. The viscose is water-solvable viscose. The compressing pressure is larger than 15 tons. In agitating step, recycling short fiber for waste paper can be added.

### FIELD OF THE INVENTION

The present invention relates to the reusing of waste corrugated paper, and particularly to a method for recycling and reusing corrugated paper. The method is easy and simple so that the time period for recycling and reusing is shortened.

### BACKGROUND OF THE INVENTION

Conventionally, there are two methods for recycling and reusing corrugated paper. In one method, corrugated paper is sunk in water and then it is agitated into pulp. Then the pulp is filled into a model so as to have a predetermined structure. Then the shaped product is dried. The process is complicated and the pulp has a great amount of water therein. Thereby, the time period of drying is long. As a result, the power required is larger. Usually, the shaped product will shrink so as to have a smaller volume.

In another method, the waste paper is sunk in the water for softening the waste paper to be as pulp. The pulp is made as corrugated paper. Then the corrugated paper is cut and adhered with each other to be as a paper plate. The whole process is very complicated and a long time period is required. Moreover, the process of cutting the corrugated paper will form a great deal of waste which must be recycled. Above steps are repeated. Thereby, the process needs much time and cost.

### SUMMARY OF THE INVENTION

Accordingly, the primary object of the present invention is to provide a method for recycling and reusing corrugated paper comprising the steps of: pulverizing the waste of corrugated paper into a plurality of scraps; adding viscose to mix with the scraps; agitating viscose and the scraps so that a surface of each scrap is stuck with a thin layer of viscose; filling the scraps with viscose into a model; compressing the scraps for solidifying the scraps so as to form a shaped product; and drying the shaped product. The size of the corrugated paper is less than 10 cm. The viscose is water-solvable viscose. The compressing pressure is larger than 15 tons. In agitating step, short fiber of waste paper can be added.

The various objects and advantages of the present invention will be more readily understood from the following detailed description when read in conjunction with the appended drawing.

### BRIEF DESCRIPTION OF THE DRAWINGS

The present invention will be better understood by reference to the accompanying drawings, wherein:

FIG. 1 shows the flow diagram about the method of the present invention.

### DETAILED DESCRIPTION OF THE PREFERRED EMBODIMENTS

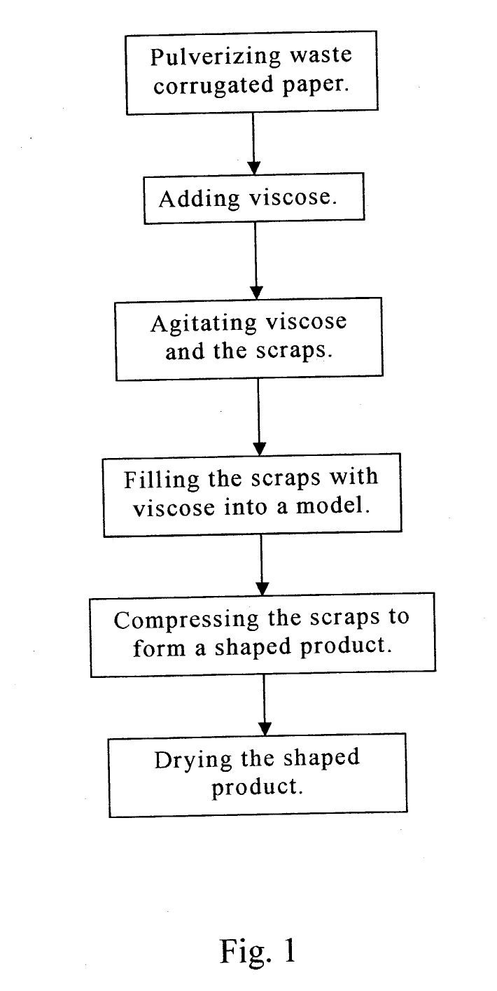

Referring to FIG. 1, the method for recycling and reusing corrugated paper of the present invention is illustrated. The method includes the following steps of:

Pulverizing the waste of corrugated paper into a plurality of scraps with fibers on the periphery of each scrap;

Adding water-solvable viscose to mix with the scraps;

Agitating water-solvable viscose and the scraps so that a surface of each scrap is stuck with a thin layer of water-solvable viscose;

Filling the scraps with water-solvable viscose into a model;

Compressing the scraps for solidifying the scraps so as to form a shaped product; in that it is preferably that the compressing pressure is above 15 tons; and

Drying the shaped product.

Moreover, in the present invention, in agitating step, recycling short fiber for waste paper can be added.

In the compressing step, if a larger pressure is applied, then a hard plate is formed. If a small pressure is applied, then a buffer plate is formed because the plate is soft and many gaps are formed in the plate.

In the present invention, it is preferably, that the size of the corrugated paper is less than 10 cm.

The present invention is better than the prior art in the following aspects:

The method for recycling and reusing corrugated paper of the present invention is easy and simple so that the time period for recycling and reusing is shortened.

The viscose is used so that only a small amount of water is mixed in the scraps. Thereby, the time for shaping and drying is shortened.

Moreover, water-solvable viscose is used. When the shaped product is reused, the process for recycling and reusing will not be affected. Thereby, the object of environment protection is achieved.

Moreover, since each scrap from the corrugated paper is a piece body with fiber being formed on the periphery of the scrap. When the viscose is agitated sufficiently, the scraps are filled into the model. Thereby, the scraps are stuck together by the viscose on the scraps. The combination of the scraps are complicated and irregularly. Thereby, the combination of the scraps are strong and it is difficult to destroy the structure of shaped products.

Moreover, the water in the shaped product is small. Thereby, it can be dried by natural wind. No extra heating process is necessary and thus power is saved. As a result, cost is reduced.

The short fiber waste paper is seldom used in the past. Thereby, the material is free charged and the manufacturing cost is reduced greatly.

Moreover, the short fiber waste paper is not used in the past and it is often the waste paper with short fiber is deserted so as to induce problem of environment protection. However, by the method of the present invention, the short fiber waste paper is used sufficiently so that the problem of environment pollution is resolved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for recycling and reusing corrugated paper comprising the steps of:
pulverizing waste corrugated paper into a plurality of scraps;
adding viscose to mix with the scraps;
agitating viscose and the scraps so that a surface of each scrap is stuck with a thin layer of viscose;
filling the scraps with viscose into a model;
compressing the scraps for solidifying the scraps to form a shaped product; and
drying the shaped product.

2. The method for recycling and reusing corrugated paper as claimed in claim 1, wherein the size of the corrugated paper is less than 10 cm.

3. The method for recycling and reusing corrugated paper as claimed in claim 1, wherein the viscose is water-solvable viscose.

4. The method for recycling and reusing corrugated paper as claimed in claim 1, wherein the compressing pressure is larger than 15 tons.

5. The method for recycling and reusing corrugated paper as claimed in claim 1, wherein pulverizing the waste of corrugated paper into a plurality of scraps with fibers on a periphery of each scrap;

6. The method for recycling and reusing corrugated paper as claimed in claim 1, wherein in agitating step, recycling short fiber for waste paper can be added.
